(19) United States
(12) Patent Application Publication
(10) Pub. No.: US 2025/0278674 A1
(43) Pub. Date: Sep. 4, 2025

(54) MACHINE LEARNING ARCHITECTURES FOR CROSS-DOMAIN CLASSIFICATION USING TRANSFER LEARNING

(71) Applicant: Intuit, Inc., Mountain View, CA (US)

(72) Inventors: Peter Benjamin TWIEG, San Jose, CA (US); Byron TANG, Mountain View, CA (US); Runhua ZHAO, San Jose, CA (US); Nalini BHARATULA, Mountain View, CA (US)

(21) Appl. No.: 18/592,340

(22) Filed: Feb. 29, 2024

(51) Int. Cl. G06N 20/20

(52) U.S. Cl. CPC G06N 20/20

(57) ABSTRACT

Certain aspects of the disclosure provide systems and methods for a cross-domain ensemble of machine learning models for onboarding new classification services. A method includes processing a classification task with an ensemble of machine learning models to generate a classification prediction, wherein the ensemble of machine learning comprises a base learner and a meta model, wherein the base learner is trained on a different domain from the classification task. The method further includes training a new classification model based on the classification prediction and data associated with the classification task.

### BACKGROUND

### Field

Aspects of the present disclosure relate to machine learning, and in particular, to machine learning models for cross-domain classification.

### Description of Related Art

The cold-start problem in machine learning modeling refers to a condition in which a machine learning model is not performant until enough training data has been gathered to train the model sufficiently. The cold start problem may also occur with a trained model when such a model is exposed to a “new” type of input data that is meaningfully different than the data upon which the model was trained.

Machine learning models are particularly well-suited for providing domain-specific outputs (e.g., inferences) when trained on sufficient domain-specific data. A domain in this context could be, for example, a type of application, business function, or even a specific user. Because it may be technically difficult to train a single model to generalize across many domains, often domain-specific machine learning models are trained and deployed for various useful functions. Training a plurality of domain-specific models generally requires extensive data engineering and model development efforts, which, in-turn, requires significant expenditure of time, processing, and cost resources.

In some cases, a domain-agnostic (e.g., generalized) model may be used instead of a domain-specific model to avoid the expenditure of time, processing and cost resources, as well as provide a model for immediate use when deploying to a new domain. However, for some critical tasks, a generalized model may not provide sufficient performance (e.g., prediction accuracy). Therefore, in such cases, the cold-start problem remains a technical problem for machine learning for new domains.

Accordingly, there is a need for improved machine learning modeling techniques for overcoming the cold-start problem and more rapidly deploying performant machine learning models to new domains.

### SUMMARY

Certain aspects provide a computer-implemented method of onboarding a new classification service, comprising: receiving a request for a target classification task, wherein no model in a plurality of machine learning models is trained for the target classification task; selecting one or more trained machine learning models from the plurality of machine learning models for a set of machine learning models; generating a set of classification predictions with the set of machine learning models, wherein each model of the set of machine learning models predicts a respective classification prediction; and processing the set of classification predictions with a meta model trained to generate a label for the target classification task.

Other aspects provide a computer-implemented method for training a new classification service, comprising: processing a classification input with an ensemble of machine learning models trained to generate a classification label; determining one or more features associated with classification data associated with the classification input; and training a new classification model based on the classification data, the one or more features, and the classification output.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system for onboarding a new application with an associated model in an ecosystem including other applications and associated models.

FIG. 2A depicts an example data flow for utilizing an ecosystem of applications and models, and FIG. 2B depicts an example data flow for onboarding a new application for the ecosystem.

FIGS. 3A-3C depict example workflows for onboarding a new classification service, including inferencing with a cross-domain ensemble model and training a new classification model for the cross-domain ensemble model.

FIG. 4 depicts an example method for onboarding a new classification application.

FIG. 5 depicts an example method for training a new classification model.

FIG. 6 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training and inferencing with cross-domain classification models.

Machine learning models (also referred to as “models” herein) serve many useful functions, including performing various types of classification tasks, which in-turn enable and/or enrich various downstream applications and services. Classification generally involves outputting a prediction (e.g., a class label) based on a given input. Consider the classic example of whether a picture includes an image of a dog or a cat. A classification model may process the input picture and output a predicted class label of “dog” or “cat.” Other examples of classification tasks include recommendation systems for a digital media application, ad-click predictions for an advertising application, spam filtering for an email service, to name just a few.

Classification-type tasks are abundant in modern electronic systems and processes. For example, in the financial domain, classification of risk is a frequent and important technical function that acts as a gate to many financial transaction types. Generally, when a classification model is to be implemented for a particular task in a given domain, there is some period of time in which the model must be trained on domain-specific data to reach a performance level sufficient to deploy the model. Practically speaking, this means that any system or processes relying on such a model may lack performant functionality when launched, or that the launch may take significantly longer while sufficient data is collected to get the underlying model trained to a sufficient performance level. As above, this is commonly referred to as the cold-start problem.

It is often the case that an entity (e.g., an organization) seeking to deploy a new model to perform a new classification task has already deployed other models that perform other classification tasks in related domains. By their related domain nature, these existing machine learning models may process certain input data (e.g., features) in common with the new machine learning model. Thus, the existing and new models have at least a subset of common features. In some examples described herein, a set of related domains may be referred to as an ecosystem.

Consider as one example, a user ID associated with a user, used for multiple different applications and/or services offered by an organization, may be a common input to existing models and the new model. If the user ID is associated with, for example, a predicted high risk of fraud with respect to one application (as predicted by an associated model), then it follows that the same user ID may indicate risk associated with the user ID for a new application. Thus, as described further herein, the “learning” of existing models (e.g., with respect to the particular user ID) in a related domain may beneficially be transferred to the new machine learning model to more rapidly and efficiently train the new model to a performance level sufficient for deployment. Moreover, the ultimate performance of the new model may exceed that of a model trained without transferring the learning from related domains.

Further, the outputs of existing models in a related domain may be ensembled and a meta model may be trained to take the outputs of each existing model as inputs in order to generate a further output that shares relevance across the related domains, such as in the risk example above. In such scenarios, the existing models may be referred to as “base models” or “base learners” of the ensemble. The output of the meta model thus benefits from the learning of all the base models as well as its own training. As has been shown in the art, an ensemble of models—even of low performance or “weak” base models—can often perform better than a single model, while also generalizing across domains more readily. Thus, the domain-specific base models plus the meta model create higher performance cross-domain models than a single model trained to generalize across multiple domains.

Moreover, the output of the meta model (e.g., a predicted classification label) may be used to rapidly generate training data for a new model in a related domain. Thus, a new model may be deployed (or “onboarded”) within an ecosystem of related domain models more quickly and with reduced expenditure of resources.

Accordingly, aspects described herein overcome the cold start problem through a combination of transfer learning and ensembling existing models in related domains to improve training efficiency and ultimate performance of individual and ensembled models in related domains. These aspects thus represent a technical improvement in the field of machine learning and engender beneficial technical effects compared to conventional techniques, such as reduced training time and reduced resource utilization (e.g., reduced compute, time, and power) when implementing a new model in a related domain. Further, the ensemble models described herein overcome technical challenges associated with single cross-domain models by improving generalization, reducing variance (e.g., sensitive to provided inputs for the learned features), improving task accuracy, and reducing feature noise and bias (e.g., in which a single model relies too heavily on too few features while making a prediction).

### Example New Application and Associated Model Onboarding System

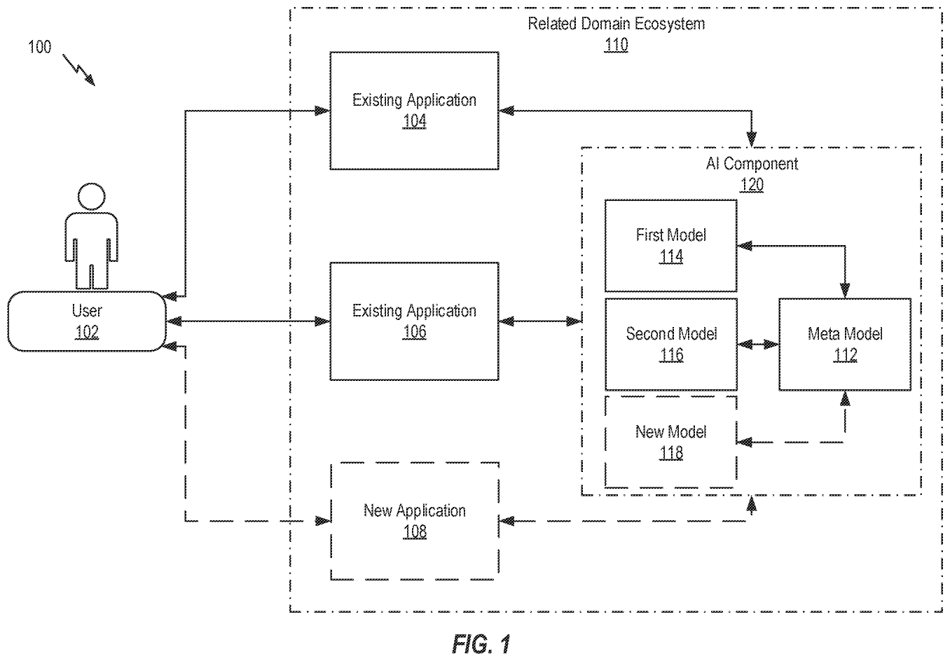

FIG. 1 depicts an example system 100 for onboarding a new application with an associated model in an ecosystem including other applications and associated models.

In particular, FIG. 1 generally depicts a user 102 that interacts with existing applications 104 and 106. User 102 may interact with one or more applications through a personal computing device (e.g., a desktop, laptop, smartphone, etc.). In this example, existing applications 104 and 106 are in a related domain ecosystem 110 (e.g., all related to media or financial services offered by an organization). Domains may be related by, for example, product or service type, application type, industry code, input data types, output data types, and the like. Often, applications in related domains will have at least some overlapping features in their input data, and may have outputs of similar type (e.g., a risk prediction). For example, domains may be delineated by input data (e.g., features based on a common schema) for a model (e.g., a base learner), and related domains may include at least a subset of features in common with the domain. Further, in this example, existing applications 104 and 106 process data from and/or associated with user 102 having one or more common features (e.g., having at least a partially common feature space). By way of example only, common features in the digit media ecosystem may include genera, mood, intensity, and rating. As another example, in the financial transaction ecosystem, common features may include transfer amount, payor identification, payee identification, and routing number.

Existing application 104 is augmented by a first model 114, existing application 106 is augmented by second model 116, and new application 108 will be augmented by new model 118 once new model 118 is trained. A technical function and benefit of system 100, then, is to train and deploy new model 118 more quickly than by conventional methods.

In the depicted example, first model 114, second model 116, new model 118, and meta model 112 are collectively an ensemble model and part of an AI component 120. In some cases, meta model 112 may be referred to as a cross-domain meta model. AI component 120 may augment and enrich the function of applications 104, 106, and 108 as well as other applications not depicted in FIG. 1, such as by way of an inferencing service application programming interface (API), micro service, or similar.

AI component 120 may implement various types of ensemble model architectures, including bootstrap aggregation (bagging), random forest, sequential decision trees, boosting, adaptive boosting (Adaboost), gradient boosting, extreme gradient boosting (XGBoost), stacking, blending, and others. First model 114, second model 116, and new model 118 may comprise base models (e.g., base learners) of the ensemble model architecture to generate respective predictive outputs. Meta model 112 serves as the base model aggregator and can perform aggregate prediction through various mechanisms, such as max voting, averaging, weighted averaging, and others. Meta model 112 utilizes the outputs of the respective base models (e.g., first model 114, second model 116, and new model 118) as input features to generate the aggregated prediction.

Consider an example in which an organization wishes to deploy new application 108 with personalization features provided by new model 118. As described herein, the cold-start problem prevents user 102 from immediately receiving personalized output from new application 108 because new model 118 is not yet trained. To overcome this issue, AI component 120 may leverage knowledge learned by first model 114 and second model 116 by way of meta model 112 to generate a useful output for new application 108. For example, a user's preference may be applicable to applications 104, 106, and 108, and therefore meta model 112 allows user 102 to have an immediate user-specific experience in new application 108 without waiting for new model 118 to be fully trained.

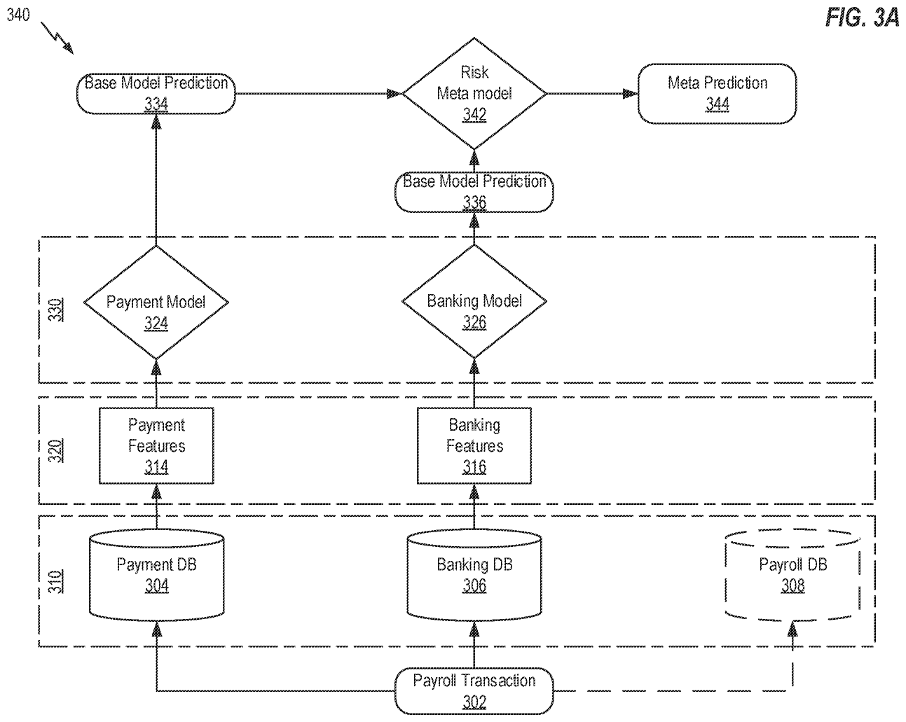

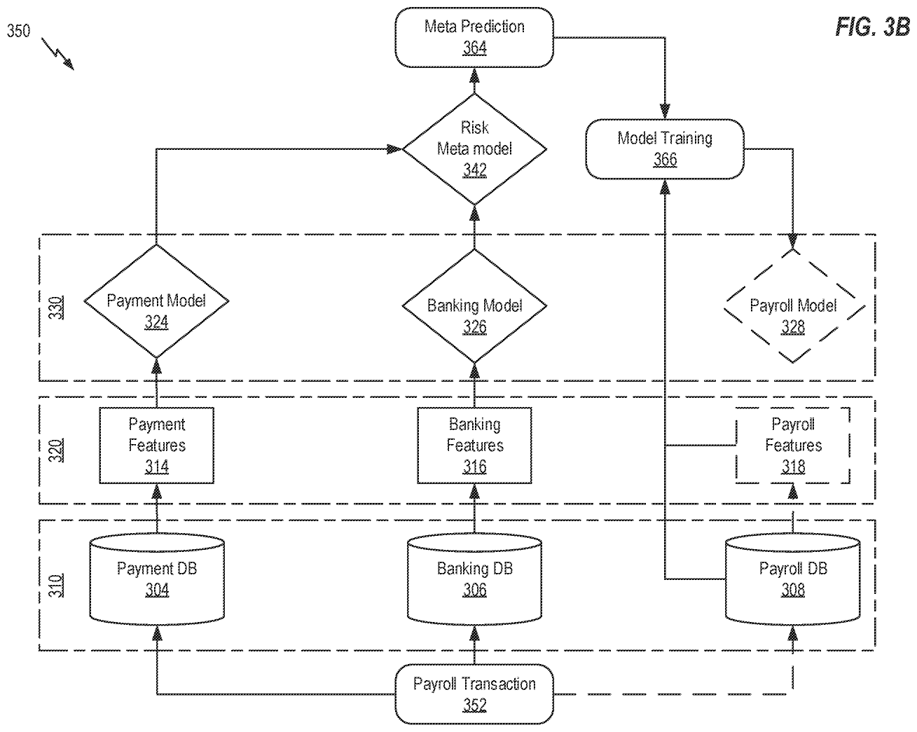

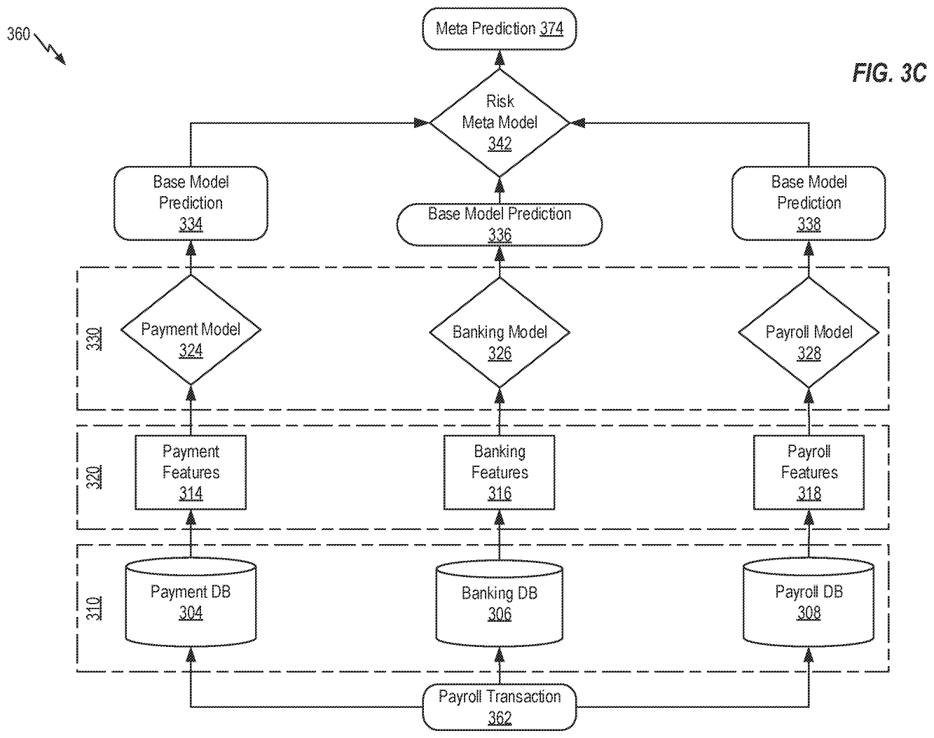

Further, the outputs of meta model 112 may be used to form training data instance for more rapidly and effectively training new model 118, as described further with respect to FIGS. 3A-3C. In this way, transfer learning may be accomplished between the various base models, including first model 114, second model 116, and new model 118 in this example. Transfer learning utilizes knowledge learned from a first task to improve performance in a second, related task. Features learned by a model in the first task may be applied to a new model in the second task. The new model may then be trained on new data associated with the second task, while utilizing the pre-trained features. For example, a feature layer of the trained model for the first task may be applied to the new model. As another example, feature layers of the trained model for the first task may be fixed (e.g., weights of features in the fixed layers may not be updated), and new layers are trained based on the second task and data.

In one example, system 100 may be used for rapidly deploying personalization a personalization model (e.g., new model 118) in support of a new application (e.g., new application 108). In particular, system 100 may be configured to facilitate deployment of personalized experiences within new application 108 based on an existing user's (e.g., user 102) personalized experience in one or more existing applications (e.g., existing applications 104 and 106) in related domains within related domain ecosystem 110. For example, a new media recommendation system powered by new model 118 may be based on user 102′s personalized recommendations in existing applications 104 and 106 (supported by models 114 and 116, respectively). Other use cases may include, for example, fraud detection in money movement related domains, image classification in a photography and videography ecosystem, document classification in document processing ecosystem, and the like. In some embodiments, related domains may be determined based on an association between tasks, for example, recommendation tasks, fraud detection, document classification, image/video classification, etc. In some embodiments, related domains may be determined based on a similarity of domains, for example, media domains, image and video domains, document domains, money management domains, etc.

In another example, system 100 may be used to rapidly make personalized recommendations. Existing first application 104 may be a music application, and the music application may use associated first model 114 to make music recommendations for user 102. Existing second application 106 may be a television application, and the television application uses associated second model 116 to make television recommendations for user 102. New application 108 may then be another media application, such a podcast application using associated new model 118 to make podcasts recommendations. Through transfer learning, new model 118 may learn to recommend podcasts based on user 102′s known preferences for certain types of television shows and music.

Accordingly, system 100 provides a way to rapidly deploy new applications and associated models to an ecosystem. AI component 120 enables faster training of new model 118 as well as improved prediction performance through meta model 112.

### Example Data Flows for Onboarding New Applications

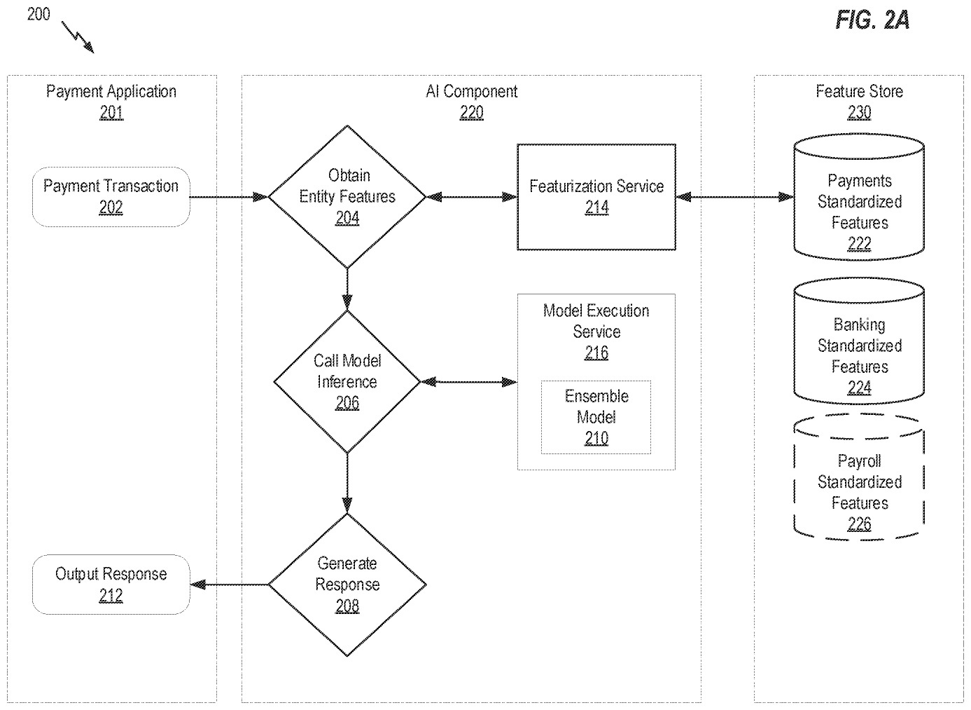

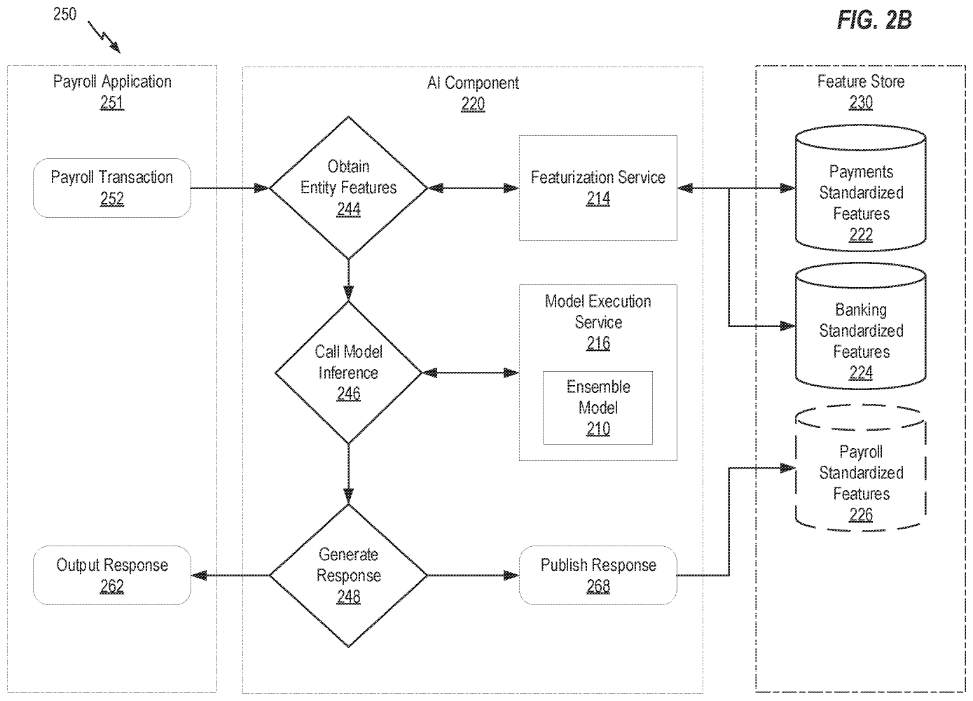

FIGS. 2A-2B depict example data flows for using the AI component described herein to onboard a new application with an associated model in an ecosystem including other applications and associated models. In particular, FIG. 2A depicts data flow 200 of payment transaction 202 through an existing application in the ecosystem, for example, existing first application 104 in FIG. 1, utilizing AI component 220 and feature store 230 to output response 212 classifying payment transaction 202. In this example, the existing application is a payment application 201 associated with a trained base model, such as first model 114 in FIG. 1.

In this example, payment transaction 202 may be a payment transaction including money movement information, for example, an amount, a date and/or timestamp, internet protocol (IP) address, payee identity, payee routing number, payee device identifier, payor identity, payor routing number, payor device identifier, etc. Such money movement information may include types of data common to a transaction for all related domains in a money movement ecosystem. For example, a payment transaction may include some or all of the same types of data as a payment, a banking transaction, and the like. Thus, payment transaction 202 may be processed by a cross-domain ensemble model 210 associated with the money management ecosystem.

AI component 220 obtains entity features at step 204 from feature store 230 through featurization service 214. Such entity features include features associated with the user, e.g., user 102, and for each domain model (e.g., first model 114 and second model 116 in FIG. 1) of cross-domain ensemble model 210. In data flow 200, payment application 201 is augmented by an existing payments model, e.g., first model 114. Features associated with this existing payments model for the user are stored in payments standardized features store 222. Featurization service 214 obtains such features from payments standardized features store 222, to be provided to model execution service 216 for inferencing at step 206.

AI component 220 calls for a model inference at step 206 from model execution service 216. AI component 220 provides entity features obtained at step 204 to model execution service 216 for execution. AI component 220 also provides payment transaction 202 information to model execution service 216. Model execution service 216 executes on the entity features obtained at step 204 to classify payment transaction 202 using cross-domain ensemble model 210. For example, model execution service 216 may execute the cross-domain ensemble model 210 associated with the ecosystem, for example, first model 114 and meta model 112, using payment transaction 202. In particular, payment transaction 202 may be provided to first model 114 to generate a fraud risk prediction, and the generated prediction provided to meta model 112 to generate an ensemble classification prediction.

The classification prediction generated by model execution service 216 is used at step 208 to output the response 212. Output response 212 may be, for example, a determination based on the classification prediction, a score, and/or the like. In the depicted example, payment transaction 202 may be classified as fraudulent or not fraudulent. For example, output response 212 may include a decision to approve payment transaction 202 and a confidence score.

FIG. 2B depicts data flow 250 of payroll transaction 252 through a new application 251 in the ecosystem, (e.g., new application 108 in FIG. 1), AI component 220 and feature store 230 to output response 262 classifying payroll transaction 252 as fraudulent or not. In the depicted example, the new application may be a payroll application and an associated user-specific domain model has not been trained, for example, new application 108 and new model 118 described in FIG. 1. However, as described herein, AI component 220 provides a cross-domain ensemble model 210 utilizing related domain models and a cross-domain meta model to generate a user-specific classification of a payroll transaction, even without a trained payroll model.

Similar to payment transaction 202, payroll transaction 252 may include money movement information, for example, an amount, a date and/or timestamp, internet protocol (IP) address, payee identity, payee routing number, payee device identifier, payor identity, payor routing number, payor device identifier, etc. Thus, information associated with payroll transaction 252 may be processed by related-domain models, for example, a payments model and a banking model.

AI component 220 obtains entity features at step 244 from feature store 230 through featurization service 214. Because payroll is a new application, little to no data on the user has been stored in payroll standardized features 226. Featurization service 214 uses features associated with the user from other domains in the ecosystem for use in the new domain, to be used by model execution service 216 with the cross-domain ensemble model 210 to generate a user-specific prediction for the new application 251.

Generally, features and associated parameter weights from one domain may be useful for determinations in other, related domains. For example, a discriminative feature in one domain may similarly be discriminative in a second domain. Thus, featurization service 214 may obtain common features from other domains for use in the new domain. As an example, features indicating higher risk of fraud may be highly correlated across domains in the money movement ecosystem. Therefore, these features may be used to transfer such learning to a new model for the new domain.

Featurization service 214 may obtain features from related domains, payments standardized features store 222 and banking standardized features store 224, to provide to model execution service 216 for inferencing with the cross-domain ensemble model.

At step 246, AI component 220 may call for an inference by the cross-domain ensemble model 210 by model execution service 216. Model execution service 216 generates an inference from the cross-domain ensemble model 210 by providing the obtained features and payroll transaction 252 to the cross-domain ensemble model 210. Cross-domain ensemble model 210 comprises base learners, e.g., first model 114 and second model 116, and a meta model, e.g., meta model 112, associated with a user and an ecosystem. As described in more detail with respect to FIGS. 3A-3C, cross-domain ensemble model 210 utilizes knowledge from the related domains to generate a classification for the new domain. In certain embodiments, a model may be trained for each domain and a meta model may be trained to process the output of each domain-specific model as input, and the meta model outputs a classification prediction. Beneficially, even where there is not a model trained for the new domain, the related domain models and the meta model may be used to generate a classification prediction for the new domain.

As an example, in a transaction using new application 251, a device associated with the payor has no historical data in the new payroll domain, but was involved in fraud in another related domain, such as a banking domain. The banking model may indicate a fraudulent transaction, such as with an elevated risk score. The cross-domain ensemble model 210 output would reflect this elevated risk of fraud determined by the banking model. Thus, beneficially, the elevated risk of fraud in the banking domain may be used across the ecosystem, in this example, in the payroll domain even though the payroll domain model may not have historical data to make such a determination. Further, by using an ensemble of domain models and an associated meta model, this cross-domain architecture may be scaled to many related domains.

At step 248, a response is generated based on the classification prediction. The output response 262 may be, for example, a determination based on the classification prediction, a score, and/or the like. For example, output response 262 may include a decision to decline the payroll transaction 252 and a confidence score. Further, at step 248, the response 268 is published to the payroll standardized features 226 in feature store 230. As described herein, such as with respect to FIG. 3B, payroll standardized features 226 may be used to train a new domain model for payroll to process subsequent payroll transactions.

Note that FIGS. 2A-2B are just examples of data flows consistent with aspects described herein, but others are possible including additional, alternative, or fewer steps.

### Example Flows for Onboarding New Classification Application

FIGS. 3A-3C depict example workflows for onboarding a new application and training a new model for an example money movement ecosystem. In embodiments, the example workflows are executed by an AI component, for example, AI component 120 in FIG. 1 or AI component 220 in FIG. 2. In this example, an AI component interacts with data store 310 comprising a database associated with each domain, in this example, payment database 304 and banking database 306. Each domain-specific database may comprise user-specific and domain-specific data and labels. Payroll database 308 is added to data store 310 when the payroll application is onboarded and stores data related to payroll transactions as payroll application is used, as described in further detail herein.

In this example, the AI component further interacts with feature store 320 configured to store features associated with each domain database, in this example, payment features 314 associated with payment database 304, and banking features 316 associated with banking database 306. The AI component includes a set of models 330 comprising a model associated with each domain, in this example, payment model 324 and banking model 326, which may be examples of first model 114 and second model 116 in FIG. 1. Each model in the set of models 330 is trained to output a classification prediction, in this example, a risk prediction, such as a fraudulent payment transaction, a returned bank transfer, etc. In particular, payment model 324 may generate a first base model prediction 334 and banking model 326 may generate a second base model prediction 336. Further, each model in the set of models 330 is trained on at least partially common feature space (e.g., having one or more common features). The AI component further includes meta model 342 configured to process the classification predictions from the set of models 330 (e.g., first base model prediction 334 and second base model prediction 336) and generate meta prediction 344. Meta model 342 is an example of cross-domain meta model 112 in FIG. 1. Together, the set of models 330 including domain-specific base learners and meta model 342 may comprise an example of cross-domain ensemble model 210 in FIG. 2.

In particular, FIG. 3A depicts an example workflow 340 for onboarding a new application, for example, the new payroll application. Initially, the new payroll application does not have an associated trained model in the AI component for this user. As described herein, the cold-start problem may prevent the user from immediately receiving a user-specific risk assessment from a new payroll application. However, the new payroll application may leverage the cross-domain ensemble model of the AI component to generate a classification output for payroll transactions in new payroll application. Trained models associated with classification tasks for similar domains, e.g., base learners for related domains, in this example, payment model 324 and banking model 326, may be used in the ensemble model to generate this classification output. The cross-domain ensemble model may be beneficially used by the new payroll application to provide the classification output for payroll transactions, even without an associated payroll-specific domain model.

In the depicted example, workflow 340 overcomes this cold-start problem by processing payroll transaction 302 with the related base learner models. Payment model 324 processes payroll transaction 302 to generate a classification prediction, first base model prediction 334, which is provided to meta model 342. First base model prediction 334 may be a risk prediction (e.g., risk of fraud) for payroll transaction 302. For example, payment model 324 may determine, if the payroll transaction was in the payment domain, whether it would be fraudulent. Beneficially, then, knowledge learned by payment model 324 may be utilized to predict whether payroll transaction is fraudulent.

Similarly, payroll transaction 302 is processed by banking model 326. Banking model 326 processes payroll transaction 302 to generate a classification prediction, second base model prediction 336, and provides the second base model prediction 336 to meta model 342. Second base model prediction 336 may be a risk prediction (e.g., risk of fraud) for payroll transaction 302, for example, if payroll transaction 302 were in the banking domain, whether banking model 326 would determine payroll transaction to be fraudulent.

Meta model 342 is trained to generate meta prediction 344 based on first base model prediction 334 and second base model prediction 336. Meta prediction 344 may indicate whether payroll transaction 302 is fraudulent based on predictions from related domains, e.g., base learners payment model 324 and banking model 326. Meta model 342 may be a meta-classifier trained on the outputs of the base learners, for example, first base model prediction 334 and second base model prediction 336 may be the inputs to meta model 342.

Meta model 342 may stack or combine the outputs from each of the base learners to determine meta prediction 344. In some embodiments, meta model 342 may determine meta prediction 344 based on the prediction among the base learners with the most votes, for example, the most frequent prediction among the base learners. In some embodiments, meta model 342 may average the outputs from the base learners, for example, averaging first base model prediction 334 and second base model prediction 336. In some embodiments, meta model 342 may determine a weighted average, for example, weights of base learners to determine a weighted average. For example, a weight may be applied to each of first base model prediction 334 and second base model prediction 336 to determine meta prediction 344. Generally, meta model 342 may have improved performance as compared to any individual model because it may minimize or reduce error in one base learner through the combination of predictions from many base learners.

Furthermore, meta model 342 may provide improved resilience as compared to a single domain-specific model because meta model 342 may not be overly reliant on a specific base learner. If a specific base learner were to have reduced performance, for example, it stopped being called or provides bad data, etc., such fragility may be reduced because meta model 342 also utilizes other base learners for prediction.

Although depicted in this example as two base learners, e.g., payment model 324 and banking model 326, in some embodiments, meta model 342 may utilize many base learner models, for example, about 100 base learners, greater than 100 base learners, about 1000 base learners, greater than 1000 base learners, etc. In some embodiments, a large number of base learners may result in poor scalability of meta model 342, and meta model 342 may be restricted to a maximum number of base learners during training of meta model 342.

Thus, beneficially, meta prediction 344 is generated for payroll transaction 302, even without a domain-specific trained model through the ensembling of the base learners for related domains and the meta model 342. Further, data associated with payroll transaction 302 is stored in payroll database 308 to facilitate later training, such as in workflow 350 of FIG. 3B.

The base learners in the set of models 330 may be identified based on related domains, similarity in target tasks, and/or association with meta model 342. In some embodiments, many base learners are trained for a variety of classification tasks and base models may be selected for inclusion in the set of models 330 base on a similarity between a base learner's respective classification task and the target classification task associated with the new application. In some embodiments, the new application is associated with a target domain, and each base learner selected for inclusion in the set of models 330 based on a similarity between the target domain and a domain of the base learner, e.g., based on at least a subset of common features. In some embodiments, base learners are selected for inclusion in the set of models 330 based on an association between the base learner and the meta model, for example, a pre-existing ensemble model. The ensemble model (including the meta model and the set of base learners) may be selected based on a similarity of the ensemble model and the new application, e.g., related domains, similar classification tasks, common data, etc.

FIG. 3B depicts an example workflow 350 for training a model for the new application as it is utilized. Over time, payroll data is accumulated and stored in payroll database 308. This data is used to generate and train a new base learner for the payroll domain, payroll model 328. Thus, payroll model 328 may be rapidly and effective trained.

In particular, a subsequent payroll transaction, second payroll transaction 352 for the new payroll application is processed, such as described with respect to FIG. 3A to generate an associated payroll prediction, meta prediction 364 from meta model 342. Payroll data associated with second payroll transaction 352 is stored in payroll database 308. Such data may be associated with meta prediction 364 to generate training data for training payroll model 328. For example, second payroll transaction 352 may be processed by payments model 324 and banking model 326, and the outputs of each base learner processed by meta model 342 to generate meta prediction 364, such as described with respect to FIG. 3A, for example, a fraudulent transaction prediction. Payroll model 328 may be instantiated and trained based on model training data 366 comprising second payroll transaction 352 and meta prediction 364 to generate a fraudulent transaction prediction for payroll transactions.

Further, each base learner in the ecosystem is trained based on a common feature space, and the new base learner, e.g., payroll model 328, utilizes such common features. Knowledge about common features may be transferred from related base learners. As an example, payroll model 328 may beneficially be further trained based on one or more model features learned in a related domain base learner through transfer learning. In some embodiments, one or more model feature weights from a related domain base learner, e.g., payments model 324 and/or banking model 326, may be used to determine one or more model feature weights of payroll model 328. By using the trained features, less additional training and added training data may be used to generate a mature model. Thus, beneficially, payroll model 328 may be trained faster, on less data, and/or with higher performance, as compared to a model trained without transfer learning.

Further, once payroll model 328 has been trained and generated, payroll model 328 may be added to the set of models 330 and used by meta model 342. Meta model 342 may then utilize payroll model 328 as a base learner, along with payment model 324 and banking model 326.

FIG. 3C depicts an example workflow 360 for inferencing with new payroll model 328, generated and trained as described with respect to FIG. 3B, as part of meta model 342. Once new payroll model 328 has matured (e.g., been fully trained as described with respect to FIG. 3B), added to the set of models 330, and ensembled with meta model 342, payroll model 328 may be used to generate meta prediction 374 for payroll transaction 362.

As depicted, payroll transaction 362 is a subsequent payroll transaction after payroll model 328 has been trained. Payroll transaction 362 is processed by a set of models 330 associated with the payroll domain and associated domains, in this example, payments and banking.

Payroll transaction 362 is processed by payment model 324 to generate first base model prediction 334, in this example, predicting whether payroll transaction 362 is fraudulent in a payment domain.

Similarly, payroll transaction 362 is processed by banking model 326 to generate second base model prediction 336, in this example, predicting whether payroll transaction 362 is fraudulent in a payment domain.

Additionally, payroll transaction 362 is processed by payroll model 328 to generate third base model prediction 338, in this example, predicting whether payroll transaction 362 is fraudulent. Payroll model 328 processes payroll transaction 362, as well as payroll data stored in payroll database 308 based on payroll features 318 to generate third base model prediction 338.

Meta model 342 generates a meta prediction 374 based on the first base model prediction 334, second base model prediction 336, and third base model prediction 338. Thus, meta prediction 374 is based on domain-specific data and a domain-specific model, e.g., payroll model 328. Further, beneficially, meta prediction 374 is also based on data and models from related domains, e.g., payments and banking. These other related domains may provide beneficial relevance when assessing the payroll transaction 362. Further, meta model 342 ensembles the set of machine learning models to provide improved performance over just one base learner, e.g., payroll model 328.

As an example, an individual entity involved in a transaction may have no history in the target domain, e.g., payroll, but was involved in fraud in a different related domain, such as banking. Based on the banking data in banking database 306, banking model 326 may determine a higher risk of fraud for the payroll transaction in the banking model. Ultimately, meta prediction 374 may have a higher risk of fraud, based in part on the banking prediction, e.g., second base model prediction 336 used by meta model 342. Thus, elevated risk in a related domain is captured by meta prediction 374.

In some embodiments, a domain may include additional features, for example, in the payments domain, a payment transaction includes a device identifier and in the banking domain a banking transaction does not include a device identifier. When the payments base learner is trained with a feature vector including a device identifier, payments transactions will have a device identifier and the payments model expects this device identifier. However, when the payments base learner processes a banking transaction without a device identifier, the model may behave erratically because of the missing feature, and thus reduce utility of a banking meta model. In some embodiments, entity sparsity enhancement may be used to nullifying sets of features related to entities in some observations during model training. Entity sparsity enhancement may be used, even after maturity, to ensure each base learner model is more robust to other input data from other, new domains as each ensemble model gains more base learners. Entity sparsity enhancement may be used to null features, such as a device identifier, to train base learners to be robust to such sparsity between domains. In some embodiments, the set of features may be nullified based on a relation between each of the features, such that all the features in the set of features may be expected to be null (e.g., missing) in the same transaction, for example, a payment transaction may generally include bank account features, for example, a bank account number, a routing number, a SWIFT code, etc. During training of the payment model, such bank account features may be nullified to ensure the payment model is trained to accommodate inputs from other domains, where such inputs may not provide such bank account features.

Note that FIGS. 3A-3C are just examples of data flows consistent with aspects described herein, but others are possible including additional, alternative, or fewer steps.

### Example Method for Onboarding a New Classification Application

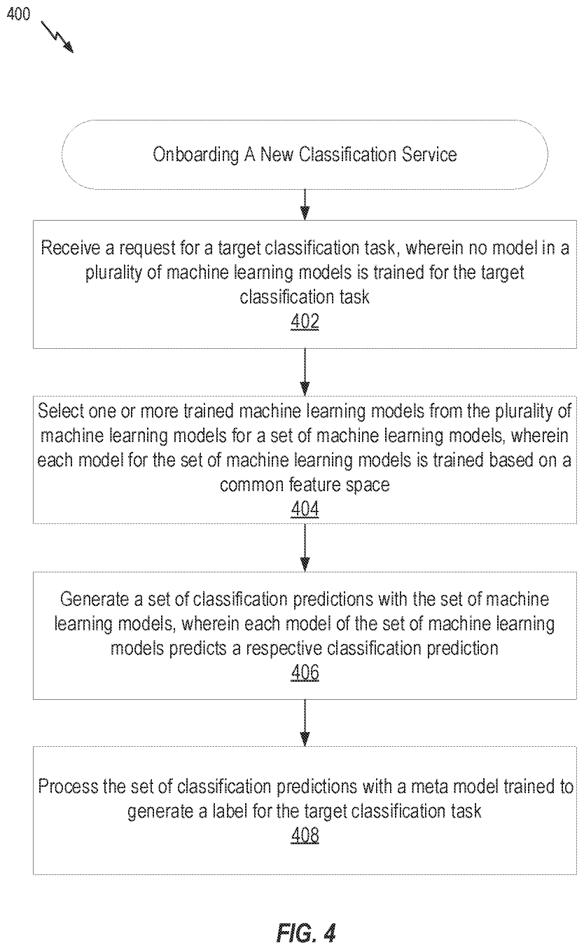

FIG. 4 depicts an example method 400 onboarding a new classification application, for example, a new application 108 in FIG. 1, or a new payroll application as described with respect to FIGS. 2A-2B, and FIGS. 3A-3C.

Initially, method 400 begins at step 402 with receiving a request for a target classification task, wherein no model in a plurality of machine learning models is trained for the target classification task, such as described with respect to FIGS. 2A and 3A. For example, a new classification task associated with the new application and there is not an existing pre-trained model for that domain-specific task.

Method 400 proceeds to step 404 with selecting one or more trained machine learning models from the plurality of machine learning models for a set of machine learning models. In some embodiments, each model of the set of machine learning models is trained based on a common feature space, and the target classification task is associated with the common feature space, for example, as described with respect to FIGS. 2A-2B. For example, the set of machine learning models in an ecosystem of related domains.

In some embodiments, each respective model of the plurality of machine learning models is trained for a respective classification task, and the one or more trained machine learning models are selected from the plurality of machine learning models based on an association between the respective classification task and the target classification task.

In some embodiments, the target classification task is associated with a target domain, each respective model in the plurality of machine learning models is trained on data associated with a respective domain, and the one or more trained machine learning models are selected from the plurality of machine learning models based on an similarity between the respective domain and the target domain.

In some embodiments, the set of machine learning models is selected based on an association of each respective model in the set of machine learning models with a meta model, and the meta model is selected based on a similarity with the target domain, e.g., related domains, common feature space, respective classification task, etc.

Method 400 then proceeds to step 406 with generating a set of classification predictions with the set of machine learning models, wherein each model of the set of machine learning models predicts a respective classification prediction, for example, first base model prediction 334 and second base model prediction 336 in FIGS. 3A-3C.

Method 400 then proceeds to step 408 with processing the set of classification predictions with a meta model trained to generate a label for the target classification task, such as meta model 342 in FIGS. 3A-3C to generate a meta prediction.

In some embodiments, method 400 further comprises training a new model to generate the label for the target classification task, for example, as described with respect to FIG. 3B. In some embodiments, method 400 further comprises adding the trained new model to the set of machine learning models, e.g., for use with a cross-domain ensemble model.

In some embodiments, method 400 further comprises receiving a second request for the target classification task; and generating a second label for the target classification task by processing the second request with the trained new model, for example, as described with respect to FIG. 3C e.g., using the cross-domain ensemble model.

Note that FIG. 4 is just one example of a method consistent with aspects described herein, but others are possible including additional, alternative, or fewer steps.

### Example Method for Training a New Classification Application

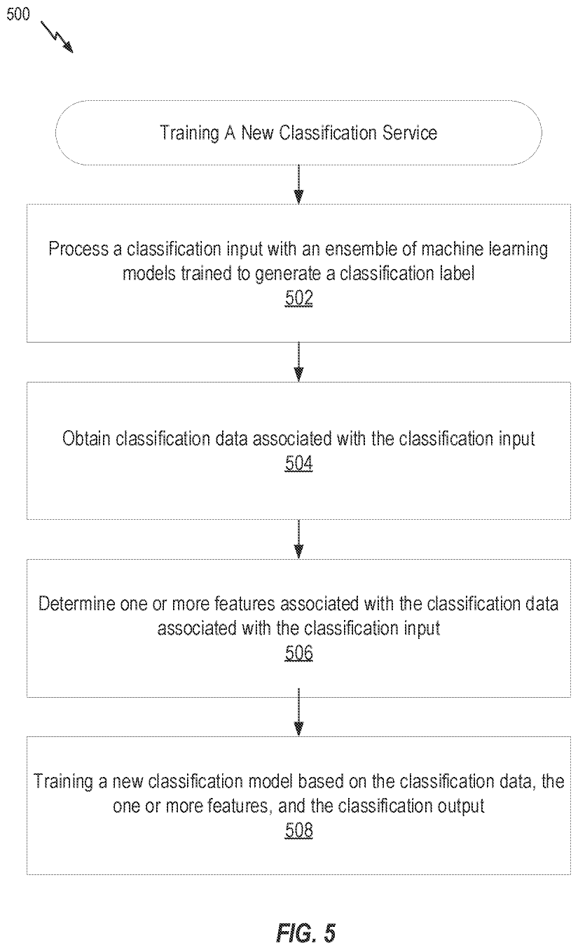

FIG. 5 depicts an example method 500 for training a new classification application, for example, a new application 108 in FIG. 1, or a new payroll application as described with respect to FIGS. 3B.

Initially, method 500 begins at step 502 with processing a classification input with an ensemble of machine learning models trained to generate a classification label. In some embodiments, the ensemble of machine learning models comprises a pre-trained classification model and a meta model, for example as described with respect to payment model 324, banking model 326, and meta model 342 in FIGS. 3A-3C.

Method 500 proceeds to step 504 with obtaining classification data associated with the classification input, for example, as described with respect to payroll database 308 in in FIGS. 3A-3C.

Method 500 then proceeds to step 506 with determining one or more features associated with the classification data for example as described with respect to payroll features 318 in FIGS. 3A-3C. In some embodiments, features may be obtained using transfer learning, for example, one or more features and parameter weights, or frozen feature layers.

Method 500 then proceeds to step 508 with training a new classification model based on the classification data, the one or more features, and the classification output, for example, as described with respect to payroll model 328 in FIG. 3B.

In some embodiments, the pre-trained classification model is associated with a first domain; the new classification model is associated with a second domain; and the classification input is associated with the second domain. In some embodiments, the pre-trained classification model and the new classification model are trained on a common feature space.

In some embodiments, method 500 further comprises adding the new classification model to the ensemble of machine learning models, e.g., the cross-domain ensemble model 210 in FIG. 2B.

Note that FIG. 5 is just one example of a method consistent with aspects described herein, but others are possible including additional, alternative, or fewer steps.

### Example Processing System for Onboarding New Applications

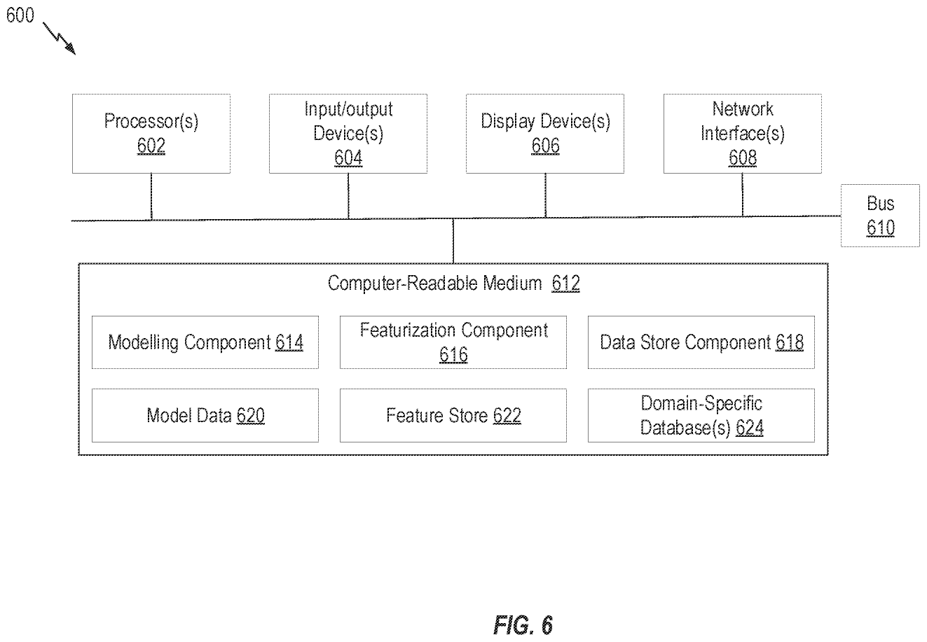

FIG. 6 depicts an example processing system 600 configured to perform various aspects described herein, including, for example, data flows for onboarding new applications as described above with respect to FIGS. 2A-2B, flows for onboarding new classification applications as described with respect to FIGS. 3A-3C, method 400 for onboarding a new classification application as described above with respect to FIG. 4, or method 500 for training a new classification application as described above with respect to FIG. 5.

Processing system 600 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, one or more network interfaces 608 through which processing system 600 is connected to one or more networks (e.g., a local network, an intranet, the Internet, or any other group of processing systems communicatively connected to each other), and computer-readable medium 612. In the depicted example, the aforementioned components are coupled by a bus 610, which may generally be configured for data exchange amongst the components. Bus 610 may be representative of multiple buses, while only one is depicted for simplicity.

Processor(s) 602 are generally configured to retrieve and execute instructions stored in one or more memories, including local memories like computer-readable medium 612, as well as remote memories and data stores. Similarly, processor(s) 602 are configured to store application data residing in local memories like the computer-readable medium 612, as well as remote memories and data stores. More generally, bus 610 is configured to transmit programming instructions and application data among the processor(s) 602, display device(s) 606, network interface(s) 608, and/or computer-readable medium 612. In certain embodiments, processor(s) 602 are representative of one or more central processing units (CPUs), graphics processing unit (GPUs), tensor processing unit (TPUs), accelerators, and other processing devices.

Input/output device(s) 604 may include any device, mechanism, system, interactive display, and/or various other hardware and software components for communicating information between processing system 600 and a user of processing system 600. For example, input/output device(s) 604 may include input hardware, such as a keyboard, touch screen, button, microphone, speaker, and/or other device for receiving inputs from the user and sending outputs to the user.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices. In various embodiments, display device(s) 606 may be configured to display a graphical user interface.

Network interface(s) 608 provide processing system 600 with access to external networks and thereby to external processing systems. Network interface(s) 608 can generally be any hardware and/or software capable of transmitting and/or receiving data via a wired or wireless network connection. Accordingly, network interface(s) 608 can include a communication transceiver for sending and/or receiving any wired and/or wireless communication.

Computer-readable medium 612 may be a volatile memory, such as a random access memory (RAM), or a nonvolatile memory, such as nonvolatile random access memory (NVRAM), or the like. In this example, computer-readable medium 612 includes modelling component 614, featurization component 616, data store component 618, model data 620, feature store 622, and domain-specific databases 624.

In certain embodiments, modelling component 614 is configured to generate, train, and execute one or more machine learning models of a plurality of machine learning models storing model data 620, for example, for the set of machine learning models and the meta model in FIG. 4, or the ensemble of machine learning models in FIG. 5. In embodiments, modelling component 614 is further configured to train a new classification model, for example as described with respect to FIG. 4 or FIG. 5. In embodiments, modelling component 614 may be an example of an AI component, for example as described with respect to FIGS. 1-3C.

In certain embodiments, featurization component 616 is configured to determine and obtain features associated with machine learning models stored in model data 620. Featurization component 616 may be further configured to store features in feature store 622, such as one or more domain-specific feature databases in feature store 230 in FIGS. 2A-2B.

In certain embodiments, data store component 618 is configured to store and retrieve domain data stored in one or more domain-specific databases 624, such as payment database 304, banking database 306, or payroll database 308, as described with respect to FIGS. 3A-3C.

Note that FIG. 6 is just one example of a processing system consistent with aspects described herein, and other processing systems having additional, alternative, or fewer components are possible consistent with this disclosure.

### Example Clauses

Implementation examples are described in the following numbered clauses:

Clause 1: A computer-implemented method for onboarding a new classification application, comprising: receiving a request for a target classification task, wherein no model in a plurality of machine learning models is trained for the target classification task; selecting one or more trained machine learning models from the plurality of machine learning models for a set of machine learning models; generating a set of classification predictions with the set of machine learning models, wherein each model of the set of machine learning models predicts a respective classification prediction; and processing the set of classification predictions with a meta model trained to generate a label for the target classification task.

Clause 2: The computer-implemented method of Clause 1, further comprising training a new model to generate the label for the target classification task.

Clause 3: The computer-implemented method of Clause 2, further comprising: receiving a second request for the target classification task; and generating a second label for the target classification task by processing the second request with the trained new model.

Clause 4: The computer-implemented method of any one of Clauses 2-3, further comprising adding the trained new model to the set of machine learning models.

Clause 5: The computer-implemented method of Clause 4, further comprising: receiving a second request for the target classification task; and generating a second label for the target classification task, comprising: generating a second set of classification predictions with the set of machine learning models and the trained new model; and processing the second set of classification predictions with the meta model trained to generate a label for the second request.

Clause 6: The computer-implemented method of any one of Clauses 1-5, wherein: each model of the set of machine learning models is trained based on a common feature space; and the target classification task is associated with the common feature space.

Clause 7: The computer-implemented method of any one of Clauses 1-6, wherein the target classification task is associated with the common feature space.

Clause 8: The computer-implemented method of any one of Clauses 1-7, wherein: each respective model of the plurality of machine learning models is trained for a respective classification task, and the one or more trained machine learning models are selected from the plurality of machine learning models based on an association between the respective classification task and the target classification task.

Clause 9: The computer-implemented method of any one of Clauses 1-8, wherein: the target classification task is associated with a target domain, each respective model in the plurality of machine learning models is trained on data associated with a respective domain, and the one or more trained machine learning models are selected from the plurality of machine learning models based on an similarity between the respective domain and the target domain.

Clause 10: The computer-implemented method of any one of Clauses 1-9, wherein the set of machine learning models and the Meta model comprise a cross-domain ensemble model.

Clause 11: A computer-implemented method for training a new classification application, comprising: processing a classification input with an ensemble of machine learning models trained to generate a classification label; obtaining classification data associated with the classification input; determining one or more features associated with the classification data; and training a new classification model based on the classification data, the one or more features, and the classification output.

Clause 12: The computer-implemented method of Clause 11, further comprising adding the new classification model to the ensemble of machine learning models.

Clause 13: The computer-implemented method of any one of Clauses 11-12, wherein the ensemble of machine learning models comprises a pre-trained classification model and a meta model.

Clause 14: The computer-implemented method of Clause 13, wherein: the pre-trained classification model is associated with a first domain; the new classification model is associated with a second domain; and the classification input is associated with the second domain.

Clause 15: The computer-implemented method of any one of Clauses 13-14, wherein the pre-trained classification model and the new classification model are trained on a common feature space.

Clause 16: A processing system, comprising: a memory comprising computer-executable instructions; and a processor configured to execute the computer-executable instructions and cause the processing system to perform a method in accordance with any one of Clauses 1-15.

Clause 17: A processing system, comprising means for performing a method in accordance with any one of Clauses 1-15.

Clause 18: A non-transitory computer-readable medium storing program code for causing a processing system to perform the steps of any one of Clauses 1-15.

Clause 19: A computer program product embodied on a computer-readable storage medium comprising code for performing a method in accordance with any one of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for onboarding a new classification service, comprising:
receiving a request for a target classification task, wherein no model in a plurality of machine learning models is trained for the target classification task;
selecting one or more trained machine learning models from the plurality of machine learning models for a set of machine learning models;
generating a set of classification predictions with the set of machine learning models, wherein each model of the set of machine learning models predicts a respective classification prediction; and
processing the set of classification predictions with a meta model trained to generate a label for the target classification task.

2. The computer-implemented method of claim 1, further comprising training a new model to generate the label for the target classification task.

3. The computer-implemented method of claim 2, further comprising:
receiving a second request for the target classification task; and
generating a second label for the target classification task by processing the second request with the trained new model.

4. The computer-implemented method of claim 2, further comprising adding the trained new model to the set of machine learning models.

5. The computer-implemented method of claim 4, further comprising:
receiving a second request for the target classification task; and
generating a second label for the target classification task, comprising:
generating a second set of classification predictions with the set of machine learning models and the trained new model; and
processing the second set of classification predictions with the meta model trained to generate a label for the second request.

6. The computer-implemented method of claim 1, wherein:
each model of the set of machine learning models is trained based on a common feature space; and
the target classification task is associated with the common feature space.

7. The computer-implemented method of claim 1, wherein:
each respective model of the plurality of machine learning models is trained for a respective classification task, and
the one or more trained machine learning models are selected from the plurality of machine learning models based on an association between the respective classification task and the target classification task.

8. The computer-implemented method of claim 1, wherein:
the target classification task is associated with a target domain,
each respective model in the plurality of machine learning models is trained on data associated with a respective domain, and
the one or more trained machine learning models are selected from the plurality of machine learning models based on a similarity between the respective domain and the target domain.

9. The computer-implemented method of claim 1, wherein the set of machine learning models and the meta model comprise a cross-domain ensemble model.

10. A computer-implemented method for training a new classification service, comprising:
processing a classification input with an ensemble of machine learning models trained to generate a classification label;
determining one or more features associated with classification data associated with the classification input; and
training a new classification model based on the classification data, the one or more features, and the classification label.

11. The computer-implemented method of claim 10, further comprising adding the new classification model to the ensemble of machine learning models.

12. The computer-implemented method of claim 10, wherein the ensemble of machine learning models comprises a pre-trained classification model and a meta model.

13. The computer-implemented method of claim 12, wherein:
the pre-trained classification model is associated with a first domain; and
the new classification model is associated with a second domain.

14. The computer-implemented method of claim 12, wherein the pre-trained classification model and the new classification model are trained on a common feature space.

15. A processing system, comprising: a memory comprising computer-executable instructions; and a processor configured to execute the computer-executable instructions and cause the processing system to:
receive a request for a target classification task, wherein no model in a plurality of machine learning models is trained for the target classification task;
select one or more trained machine learning models from the plurality of machine learning models for a set of machine learning models;
generate a set of classification predictions with the set of machine learning models, wherein each model of the set of machine learning models predicts a respective classification prediction; and
process the set of classification predictions with a meta model trained to generate a label for the target classification task.

16. The processing system of claim 15, wherein the processor is further configured to cause the processing system to train a new model to generate the label for the target classification task.

17. The processing system of claim 16, wherein the processor is further configured to cause the processing system to:
receive a second request for the target classification task; and
generate a second label for the target classification task by processing the second request with the trained new model.

18. The processing system of claim 16, wherein the processor is further configured to cause the processing system to add the trained new model to the set of machine learning models.

19. The processing system of claim 18, wherein the processor is further configured to cause the processing system to:
receive a second request for the target classification task; and
generate a second label for the target classification task, comprising:
generate a second set of classification predictions with the set of machine learning models and the trained new model; and
process the second set of classification predictions with the meta model trained to generate a label for the second request.

20. The processing system of claim 15, wherein:
the target classification task is associated with a target domain,
each respective model in the plurality of machine learning models is trained on data associated with a respective domain, and
the one or more trained machine learning models are selected from the plurality of machine learning models based on a similarity between the respective domain and the target domain.
